(19) United States
(12) Patent Application Publication
(10) Pub. No.: US 2006/0226975 A1
(43) Pub. Date: Oct. 12, 2006

(54) Device locating system

(76) Inventors: Ernest F. Keebler JR., Marlton, NJ (US); Michael B. Cray, Mount Laurel, NJ (US); Michael Abbate, Vineland, NJ (US)

Correspondence Address: LITMAN LAW OFFICES, LTD, PO BOX 15035, CRYSTAL CITY STATION, ARLINGTON, VA, 22215, US

(21) Appl. No.: 11/101,600

(22) Filed: Apr. 8, 2005

(51) Int. Cl. G08B 1/08

(52) U.S. Cl. 340/539.29; 340/825.49

(57) ABSTRACT

A device locating system includes an activator with activator circuitry, and a device locating arrangement with removable device locating circuitry contained therein. The activator circuitry includes a power source, control logic, a user interface, a transceiver, and an antenna. The control logic is configured to receive input from the user interface, and to cause the transceiver to send a signal upon associated input from the user interface. The activator circuitry can include an audio indicator and/or a visual indicator. The device locating circuitry includes a power source, memory, a processor, a voltage regulator, a transceiver, and an antenna. The processor is configured to receive and process signals, and cause the transceiver to send a receipt signal upon receiving a signal from the activator. The device locating circuitry can include an audio indicator and/or a visual indicator. The device locating circuitry can be configured in the form of a battery.

### BACKGROUND OF THE INVENTION

1. Field of the Invention

The present invention generally relates to object locators and, more particularly, to a device locating system.

2. Description of Related Art

A wide variety of arrangements for locating objects are well known. For example, remote control devices easily become lost in the sofa, in the kitchen, under books, etc. Numerous arrangements for finding remote control devices are known. Typically, these types of arrangements include a remote control device with a transmitting and/or receiving device integrally contained therein, and a separate device with a transmitting and/or receiving device integrally contained therein. When the remote control device becomes lost, an individual can use the device separate from the remote control device and send a signal to the remote control device. The remote control device responds to the signal and lights up and/or produces an audible beep or tone.

However, the integral nature of the components of these arrangements limits their use to only the particular devices for which they are designed. No one has yet provided a device locating system that can be conveniently utilized with any number of battery powered devices configured in the form of standard battery. Therefore, a need exists to provide a device locating system that can be conveniently utilized with any number of battery powered devices configured in the form of standard battery.

### SUMMARY OF THE INVENTION

The present invention is a device locating system. The device locating system includes an activator with activator circuitry and a device locating arrangement with removable device locating circuitry contained therein. The activator circuitry includes a power source, control logic, a user interface, a transceiver, and an antenna. The activator circuitry can also include an audio indicator and a visual indicator, if desired. These components are communicatively interconnected by a communication bus. The activator circuitry can be contained in an independent activator device or can be integrated in another device configured to provide another function.

The power source can be a rechargeable and/or can be external to the activator and provided to the activator via a power cord or the like. The control logic is configured to receive input from the user interface, and to cause the transceiver to send a signal upon associated input from the user interface. The control logic can also be configured to cause the audio indicator and/or visual indicator, if included, to activate upon effective communication with the device locating circuitry in a device locating arrangement.

The user interface can be configured in the form of a button, key, or the like, so a user may touch, hit, or otherwise engage the user interface to cause a signal to be transmitted from the activator. The user interface may also be configured in the form of a display which can be any type of display, such as a liquid crystal display (LCD), an organic LCD, a light emitting diode (LED) display, an organic LED display (OLED), a thin film transistor display, or the like. Such a display can also be a touch sensitive screen (“touch screen”) to enable users to cause the activator to send a signal by touching the surface adjacent an indicated button icon or the like.

The audio indicator, if included, can be a speaker that is powered by an amplifier to emit any distinctive audible sound, such as a buzzer, chirp, chime, or the like. Alternatively, the audio indicator can be a speaker that relays audible communication information, such a recorded message, a relayed communication message, or the like. The visual indicator, if included, is configured to provide a visual indication for indicating communication between the activator and the device locating arrangement, or another desired reason. Such a visual indicator can emit light to provide the visual indication and can be an LED of any desired color, but may be any type of light.

The transceiver can be of a type well known in the art, and is preferably constructed of miniaturized solid state components so the transceiver can be removably received in the activator circuitry. The transceiver can establish a two-way wireless communication link between the activator circuitry and the device locating arrangement by way of the antenna.

The device locating circuitry includes a power source, memory, a processor, a voltage regulator, a transceiver, and an antenna. The device locating circuitry can also include an audio indicator and a visual indicator, if desired. These components are communicatively interconnected by a communication bus.

The power source can be a rechargeable and/or non-rechargeable battery. The memory can have software embodied thereon. The memory can be configured as read only memory (ROM) and/or random access memory (RAM). In general, ROM is used to contain instructions and programs while RAM is employed for operating and working data. The memory can also be configured in the form of a removable memory device, such as flash memory, memory stick, or any other type of removable memory device. The memory can be removable or non-removable by the user. The processor can be any type of processor and is configured to receive and output commands to the various components of the device locating circuitry. Alternatively, the memory and processor can be configured together in the form of a Programmable System On Chip (PSOC), or as control logic as described above for the activator. Similarly, the control logic of the activator can be alternatively configured in the form of memory and a processor.

The memory and processor work together to receive and process signals from the activator. Signals from other signal sources are screened by the processor so they do not cause the audio indicator and/or visual indicator to become active. The processor can be configured to cause the transceiver to send a receipt signal upon receiving a signal from the activator. The processor is configured to cause the audio indicator and/or visual indicator, if included, to activate upon effective communication with the device locating circuitry.

The voltage regulator can be any type of voltage regulator and is configured to receive power from the power source and process the voltage from the power source to cause the voltage to become a voltage level suitable for powering the device locating circuitry. The audio indicator, if included, can be a speaker that is powered by an amplifier to emit any distinctive audible sound, such as a buzzer, chirp, chime, or the like. Alternatively, the audio indicator can be a speaker that relays audible communication information, such a recorded message, a relayed communication message, or the like.

The visual indicator, if included, is configured to provide a visual indication for indicating communication between the activator and the device locating circuitry, or another desired reason. Such a visual indicator can emit light to provide the visual indication and can be an LED of any desired color, but may be any type of light. The transceiver can be of a type well known in the art, and is preferably constructed of miniaturized solid state components so the transceiver can be removably received in the device locating arrangement. The transceiver can establish a two-way wireless communication link between the activator and the device locating circuitry by way of the antenna. The device locating arrangement can be configured as a battery to place in a battery compartment of a battery powered device.

### BRIEF DESCRIPTION OF THE DRAWINGS

FIG. 1 is an environmental view of an individual using of a device locating system example according to the present invention.

FIG. 2 is a diagram of a device locating system example according to the present invention.

FIG. 3 is a block diagram of activator circuitry for use with a device locating system according to the present invention.

FIG. 4 is a block diagram of device locating circuitry for use with a device locating system according to the invention.

FIG. 5 is perspective view of an example of a device locating arrangement according to the present invention.

FIG. 6 is a front view of a locating device arrangement according to the present invention.

Similar reference characters denote corresponding features consistently throughout the attached drawings.

### DETAILED DESCRIPTION OF THE PREFERRED EMBODIMENTS

The present invention is a device locating system. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

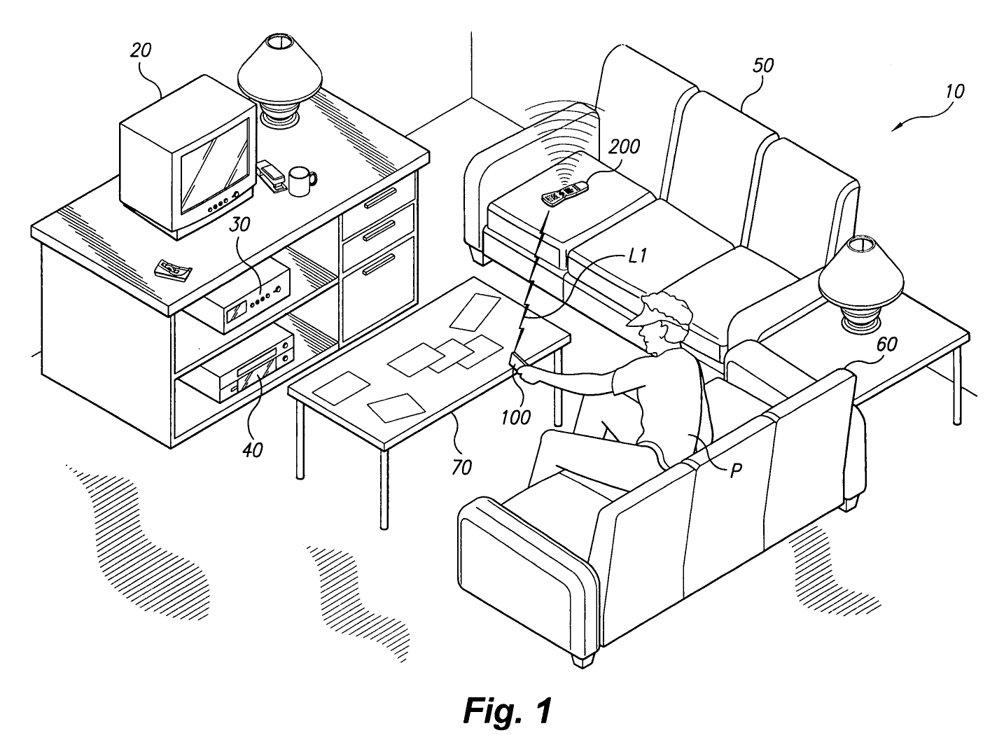

Referring to the drawings, FIG. 1 shows a room 10 with an individual P using components of a device location system according to the present invention. The room 10 includes a TV, electrical components 30 and 40, such as a DVD player, a VCR, a CD player, etc. The room 10 also includes furniture including seating arrangements 50 and 60, such as couches or the like, and a table 70. The individual P is using an activator 100 to locate a device locating arrangement 200 via a communication link L1. The activator 100 includes activator circuitry and the device locating arrangement 200 has removable device locating circuitry contained therein. In this example, the activator 100 is configured in the form of a small device convenient for hand held use, such as a key fob, an alarm activator, or the like. The device locating arrangement 200 is configured in the form of a remote control device. However, the device locating activator 100 can be configured in any desired manner and can, alternatively, be integrated in a device configured for another purpose, such as a TV set, furniture, a bookshelf, etc.

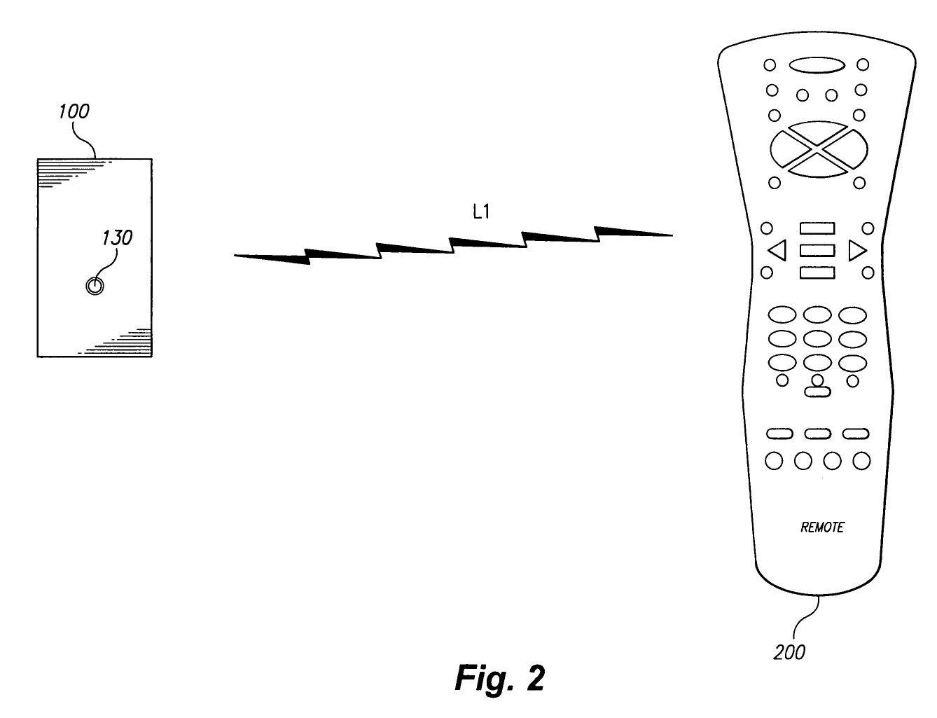

FIGS. 2-4 show more particularly the activator 100 with activator circuitry and the device locating arrangement 200 with removable device locating circuitry contained therein. The device locating arrangement 200 can be configured in the form of any desired type of battery powered arrangement, such as a flashlight, portable light, clock, pager, personal digital assistant (PDA), cellular phone (cell phone), laptop computer, smart phone, BlackBerry, portable motorized hand tool, radio, cassette player, watch, portable digital video disc (DVD) player, battery operated testing device, laser pointer, etc.

When the remote control 200 becomes lost, an individual can engage a user interface 130 on the activator 100 to cause a radio frequency (RF) signal to be sent from the activator 100 for a predetermined distance range, such as around twenty to one fifty feet, or the like. The activator 100 is configured to wirelessly transmit and/or receive information over a communication link L1 using any desired RF frequency, such as unlicensed radio, optical transmission, Infrared Data Association (IrDA) compliant, BlueTooth, 802.11 Standard, WiFi, or any other RF data communications protocol compliant methods.

For example, the activator 100 may transmit and/or receive information using BlueTooth or WiFi communication protocols. BlueTooth and WiFi devices are designed to transmit short bursts or packets of data over short ranges using unlicensed high-frequency channels such as the 2.4 GHz frequency band. Such communication protocols typically establish a frequency-hopping radio link using many different frequencies at approximately 1 MHz intervals to give a high degree of immunity from interference with other transmissions.

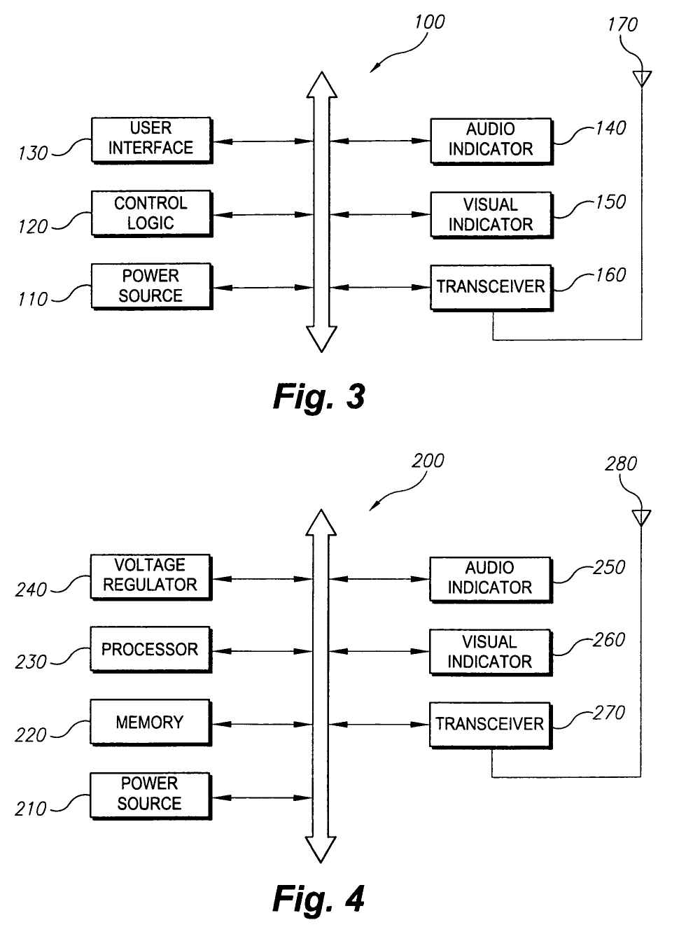

Referring to FIG. 3, the activator circuitry 100 includes a power source 110, control logic 120, a user interface 130, a transceiver 160, and an antenna 170. The activator circuitry 100 can also include an audio indicator 140 and a visual indicator 150, if desired. These components are communicatively interconnected by a communication bus. As described above, the activator circuitry 100 can be contained in an independent activator device or can be integrated in another device configured to provide another function.

The power source 110 can be a rechargeable and/or non-rechargeable battery. Alternatively, the power source 110 may be external to the activator 100 and provided to the activator 100 via a power cord or the like. The control logic 120 is configured to receive input from the user interface 130, and to cause the transceiver 160 to send a signal upon associated input from the user interface 130. The control logic can also be configured to cause the audio indicator and/or visual indicator, if included, to activate upon effective communication with the device locating circuitry in a device locating arrangement 200.

The user interface 130 can be configured in the form of a button, key, or the like, so a user may touch, hit, or otherwise engage the user interface 130 to cause a signal to be transmitted from the activator 100. The user interface 130 may also be configured in the form of a display which can be any type of display, such as an LCD, an organic LCD, an LED display, an OLED, a thin film transistor display, or the like. Such a display can also be a touch sensitive screen (“touch screen”) to enable users to cause the activator 100 to send a signal by touching the surface adjacent an indicated button icon or the like.

The audio indicator 140, if included, can be a speaker that is powered by an amplifier to emit any distinctive audible sound, such as a buzzer, chirp, chime, or the like. Alternatively, the audio indicator 140 can be a speaker that relays audible communication information, such a recorded message, a relayed communication message, or the like.

The visual indicator 150, if included, is configured to provide a visual indication for indicating communication between the activator 100 and the device locating arrangement 200, or another desired reason. Such a visual indicator 150 can emit light to provide the visual indication and can be an LED of any desired color, but may be any type of light.

The transceiver 160 can be of a type well known in the art, and is preferably constructed of miniaturized solid state components so the transceiver 160 can be removably received in the activator circuitry 100. The transceiver 160 can establish a two-way wireless communication link between the activator circuitry 100 and the device locating arrangement 200 by way of the antenna 170.

Referring to FIG. 4, the device locating circuitry 200 includes a power source 210, memory 220, a processor 230, a voltage regulator 240, a transceiver 270, and an antenna 280. The device locating circuitry 200 can also include an audio indicator 250 and a visual indicator 260, if desired. These components are communicatively interconnected by a communication bus.

The power source 210 can be a rechargeable and/or non-rechargeable battery. The memory 220 can have software embodied thereon. The memory 220 can be configured as ROM and/or RAM. In general, ROM is used to contain instructions and programs while RAM is employed for operating and working data. The memory 220 can also be configured in the form of a removable memory device, such as flash memory, memory stick, or any other type of removable memory device. The memory 220 can be removable or non-removable by the user. The processor 230 can be any type of processor and is configured to receive and output commands to the various components of the device locating circuitry 200. Alternatively, the memory 220 and processor 230 can be configured together in the form of a Programmable System On Chip (PSOC), or as control logic as described above for the activator 100. Similarly, the control logic of the activator can be alternatively configured in the form of memory and a processor.

The memory 220 and processor 230 work together to receive and process signals from the activator 100. Signals from other signal sources are screened by the processor 230 so they do not cause the audio indicator 250 and/or visual indicator 260 to become active. The processor 230 can be configured to cause the transceiver 270 to send a receipt signal upon receiving a signal from the activator 100. The processor 230 is configured to cause the audio indicator 250 and/or visual indicator 260, if included, to activate upon effective communication with the device locating circuitry 200.

The voltage regulator 240 can be any type of voltage regulator and is configured to receive power from the power source 210 and process the voltage from the power source to cause the voltage to become a voltage level suitable for powering the device locating circuitry 200. The audio indicator 250, if included, can be a speaker that is powered by an amplifier to emit any distinctive audible sound, such as a buzzer, chirp, chime, or the like. Alternatively, the audio indicator 250 can be a speaker that relays audible communication information, such a recorded message, a relayed communication message, or the like.

The visual indicator 260, if included, is configured to provide a visual indication for indicating communication between the activator 100 and the device locating circuitry 200, or another desired reason. Such a visual indicator 260 can emit light to provide the visual indication and can be an LED of any desired color, but may be any type of light. The transceiver 270 can be of a type well known in the art, and is preferably constructed of miniaturized solid state components so the transceiver 270 can be removably received in the device locating circuitry. The transceiver 270 can establish a two-way wireless communication link between the activator 100 and the device locating circuitry 200 by way of the antenna 280.

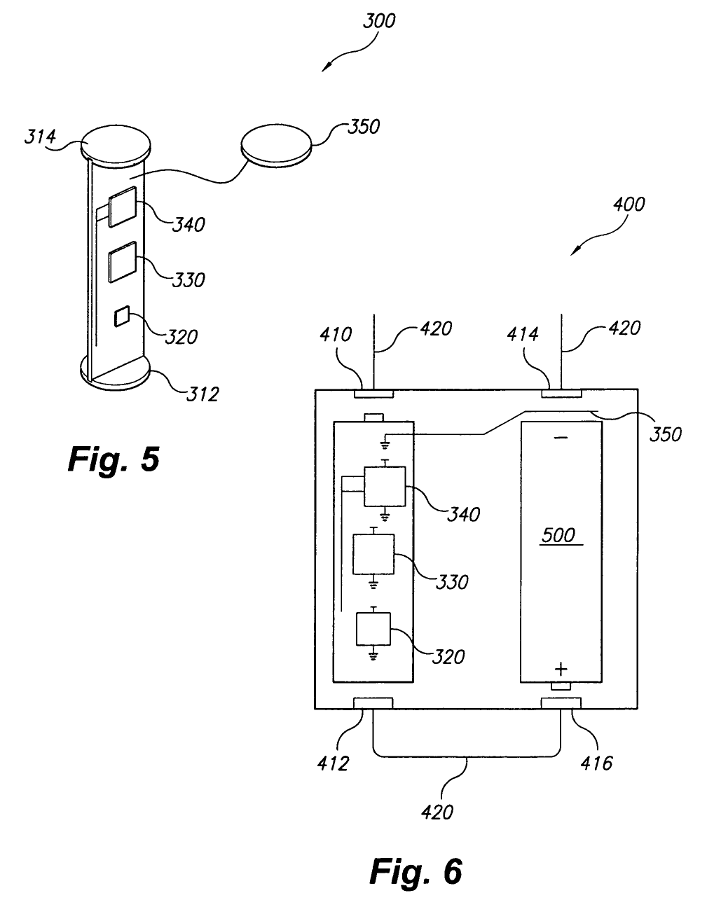

Referring to FIGS. 5 and 6, a device locating arrangement 300 is configured as a battery to place in a battery compartment 400 of a battery powered device. For example, in a device that operates using two AA batteries, such as a remote control device, the device locating arrangement 300 can include an element configured in the form of a AA battery. This element includes a base 312 and a top 314 and a circuit board carrying device locating circuitry. The illustrated elements include a voltage regulator 320, a transceiver and control circuit 330, and an audio and/or visual indicator 340. A ground element 350 can be interconnected with the device locating circuitry to properly ground out the circuit board upon interconnection with a AA battery 500 placed inside of the battery compartment 400.

The battery compartment includes positive and negative contacts 410 and 412 for interconnecting with the device locating arrangement 300, and negative and positive contacts 414 and 416 for interconnecting with the AA battery 500. Wiring 420 interconnects the contacts 410 and 414 to external points, and interconnects the contacts 412 and 416 to each other. The device locating arrangement 300 can be configured in the form of any type of battery (e.g., AA, AAA, C, D, etc.). The present invention provides significant advantages over other locating arrangements because a user merely needs to obtain a device locating arrangement configured in the form of a battery for a desired battery powered device and, upon placing the properly configured device locating arrangement in the batter compartment 400, the user can easily locate the device by sending a signal from a corresponding activator 100.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings

We claim:

1. A device locating system comprising:
an activator with activator circuitry; and
a device locating arrangement with removable device locating circuitry contained therein.

2. The device locating system according to claim 1, wherein said activator circuitry comprises:
a power source;
control logic;
a user interface;
a transceiver; and
an antenna.

3. The device locating system according to claim 2, wherein said power source is a rechargeable battery.

4. The device locating system according to claim 2, wherein said power source is a non-rechargeable battery.

5. The device locating system according to claim 2, wherein said control logic is configured to receive input from the user interface, and to cause the transceiver to send a signal upon associated input from the user interface.

6. The device locating system according to claim 5, wherein said activator circuitry further comprises an audio indicator.

7. The device locating system according to claim 6, wherein said control logic is configured to cause the audio indicator to activate upon effective communication with the device locating circuitry.

8. The device locating system according to claim 5, wherein said activator circuitry further comprises a visual indicator.

9. The device locating system according to claim 8, wherein said control logic is configured to cause the visual indicator to activate upon effective communication with the device locating circuitry.

10. The device locating system according to claim 1, wherein said activator is configured in an independent activator device.

11. The device locating system according to claim 1, wherein said activator is integrated in device configured to provide a function other than the function of the activator.

12. The device locating system according to claim 1, wherein said device locating circuitry comprises:
a power source;
memory;
a processor;
a voltage regulator;
a transceiver; and
an antenna.

13. The device locating system according to claim 12, wherein said power source is a rechargeable battery.

14. The device locating system according to claim 12, wherein said power source is a non-rechargeable battery.

15. The device locating system according to claim 12, wherein said processor is configured to receive and process signals from the activator, and cause the transceiver to send a receipt signal upon receiving a signal from the activator.

16. The device locating system according to claim 15, wherein said activator circuitry further comprises an audio indicator.

17. The device locating system according to claim 16, wherein said processor is configured to cause the audio indicator to activate upon effective communication with the activator.

18. The device locating system according to claim 15, wherein said activator circuitry further comprises a visual indicator.

19. The device locating system according to claim 18, wherein said control logic is configured to cause the visual indicator to activate upon effective communication with the activator.

20. The device locating system according to claim 12, wherein said device locating circuitry is configured in the form of a battery.
